(19) United States
(12) Patent Application Publication
(10) Pub. No.: US 2003/0202590 A1
(43) Pub. Date: Oct. 30, 2003

(54) Video encoding using direct mode predicted frames

(76) Inventors: Qunshan Gu, Londonderry, NH (US); Qi Wang, Santa Clara, CA (US); Wei Qi, Santa Clara, CA (US); Sho Long Chen, Saratoga, CA (US)

Correspondence Address: BEVER HOFFMAN & HARMS, LLP, TRI-VALLEY OFFICE, 1432 CONCANNON BLVD., BLDG. G, LIVERMORE, CA, 94550, US

(21) Appl. No.: 10/136,618

(22) Filed: Apr. 30, 2002

(51) Int. Cl. H04N 7/12

(52) U.S. Cl. 375/240.13; 375/240.12

(57) ABSTRACT

A method and system is provided for encoding a digital video stream, which requires less computation overhead as compared to conventional systems. Specifically, the encoded digital video stream includes direct mode predicted frames in place of some of the standard predicted frames. The direct mode predicted frames are formed without computing motion vectors for each macro-block of the direct mode predicted frame. During decoding, motion vectors from a co-located macro-block of a preceding predicted frame is copied and applied to each macro-block of the direct mode predicted frame. Because computing motion vectors is generally the most computing intensive task of encoding digital video streams, the use of direct mode predicted frames can greatly reduce the computation requirements for encoding digital video streams.

### BACKGROUND OF THE INVENTION

1. Field of the Invention

The present invention relates to digital video encoding, such as MPEG and AVI. More specifically, the present invention relates to methods of reducing computational overhead of using motion estimation for encoding digital images of a digital video stream. Discussion of Related Art

Due to the advancement of semiconductor processing technology, integrated circuits (ICs) have greatly increased in functionality and complexity. With increasing processing and memory capabilities, many formerly analog tasks are being performed digitally. For example, images, audio and even full motion video can now be produced, distributed, and used in digital formats.

FIG. 1(a) is an illustrative diagram of a digital video stream 100. Digital video stream 100 comprises a series of individual digital images 100_0 to 100_N, each digital image of a video stream is often called a frame. For full motion video a video frame rate of 60 images per second is desired. As illustrated in FIG. 1(b), a digital image 100_Z comprises a plurality of picture elements (pixels). Specifically, digital image 100_Z comprises Y rows of X pixels. For clarity, pixels in a digital image are identified using a 2-dimensional coordinate system. As shown in FIG. 1(b), pixel P(0,0) is in the top left corner of digital image 100_Z. Pixel P(X-1,0) is in the top right corner of digital image 100_Z. Pixel P(0,Y-1) is in the bottom left corner and pixel P(X-1, Y-1) is in the bottom right corner. Typical image sizes for digital video streams include 720×480, 640×480, 320×240 and 160×120.

FIG. 2 shows a typical digital video system 200, which includes a video capture device 210, a video encoder 220, a video channel 225, a video decoder 230, a video display 240, and an optional video storage system 250. Video capture device 210, typically a video camera, provides a video stream to video encoder 220. Video encoder 220 digitizes and encodes the video stream and sends the encoded digital video stream over channel 225 to video decoder 230. Video decoder 230 decodes the encoded video stream from channel 225 and displays the video images on video display 240. Channel 225 could be for example, a local area network, the internet, telephone lines with modems, or any other communication connections. Video decoder 230 could also receive a video data stream from video storage system 250. Video storage system 250 can be for example, a video compact disk system, a hard disk storing video data, or a digital video disk system. The video stream from video storage system 250 could have been previously generated using a video capture device and a video encoder. However, some video streams may be artificially generated using computer systems.

A major problem with digital video system 200 is that channel 225 is typically limited in bandwidth. As explained above a full-motion digital video stream can comprise 60 images a second. Using an image size of 640×480, a full motion video stream would have 18.4 million pixels per second. In a full color video stream each pixel comprises three bytes of color data. Thus, a full motion video stream would require a transfer rate in excess of 52 megabytes a second over channel 225. For internet application most users can only support a bandwidth of approximately 56 Kilobits per second. Thus, to facilitate digital video over computer networks, such as the internet, digital video streams must be compressed.

One way to reduce the bandwidth requirement of a digital video stream is to avoid sending redundant information across channel 225. For example, as shown in FIG. 3, a digital video stream includes digital image 301 and 302. Digital image 301 includes a video object 310_1 and video object 340_1 on a blank background. Digital image 302 includes a video object 310_2, which is the same as video object 310_1, and a video object 340_2, which is the same as video object 340_1. Rather then sending data for all the pixels of digital image 301 and digital image 302, a digital video stream could be encoded to simply send the information that video object 310_1 from digital image 301 has moved three pixels to the left and two pixels down and that video object 340_1 from digital image 301 has moved one pixel down and four pixels to the left. Thus rather than sending all the pixels of image 302 across channel 225, video encoder 220 can send digital image 301 and the movement information, usually encoded as a two dimensional motion vector, regarding the objects in digital image 301 to video decoder 230. Video decoder 230 can then generate digital image 302 using digital image 301 and the motion vectors supplied by video encoder 220. Similarly, additional digital images in the digital video stream containing digital images 301 and 302 can be generated from additional motion vectors.

However, most full motion video streams do not contain simple objects such as video objects 310_1 and 340_1. Object recognition in real life images is a very complicated and time-consuming process. Thus, motion vectors based on video objects are not really suitable for encoding digital video data streams. However, it is possible to use motion vector encoding with artificial video objects. Rather than finding distinct objects in a digital image, the digital image is divided into a plurality of macroblocks. A macroblock is a number of adjacent pixels with a predetermined shape and size. Typically, a rectangular shape is used so that a rectangular digital image can be divided into an integer number of macroblocks. FIG. 4 illustrates a digital image 410 that is divided into a plurality of square macroblocks. For clarity, macroblocks are identified using a 2-dimensional coordinate system. As shown in FIG. 4, macroblock MB(0,0) is in the top left corner of digital image 410. Macroblock MB(X-1,0) is in the top right corner of digital image 410. Macroblock MB(0,Y-1) is in the bottom left corner and macroblock MB(X-1, Y1) is in the bottom right corner. As illustrated in FIG. 5(a), a typical size for a macroblock 510 is eight pixels by eight pixels. As illustrated in FIG. 5(b), another typical size for a macroblock is 16 pixels by 16 pixels. For convenience, macroblocks and digital images are illustrated with bold lines after every four pixels in both the vertical and horizontal direction. These bold lines are for the convenience only and have no bearing on actual implementation of embodiments of the present invention.

To encode a digital image using macroblocks and motion vectors, each macroblock MB(x, y) of a digital image is compared with the preceding digital image to determine which area of the preceding image best matches macroblock MB(x, y). For convenience, the area of the preceding image best matching a macroblock is called an origin block OB. Typically, an origin block has the same size and shape as the macroblock. To determine the best matching origin block, a difference measure is used to measure the amount of difference between the macroblock and each possible origin block. Typically, a value such as the luminance of each pixel in the macroblock is compared to the luminance of a corresponding pixel in the origin block. The sum of absolute differences (SAD) of all the values (such as luminance) is the difference measure. Other embodiments of the present invention may use other difference measures. For example, one embodiment of the present invention uses the sum of square differences as the difference measures. For clarity, only SAD is described in detail, those skilled in the art can easily adapt other difference measures for use with different embodiments of the present invention. The lower the difference measure the better the match between the origin block and the macroblock.

The motion vector for macroblock MB(x, y) is simply the two-dimensional vector which defines the difference in location of a reference pixel on the origin block with a corresponding reference pixel on the macroblock. For convenience, the reference pixel in the examples contained herein uses the top left pixel of the macroblock and the origin block as the reference pixel. Thus for example, the reference pixel of macroblock MB(0,0) of FIG. 4 is pixel(0,0). Similarly the reference pixel of macroblock MB(X-1, Y-1) assuming an 8×8 reference block is pixel P(8*(X-1), 8*(Y-1)).

FIGS. 6(a)-6(f) illustrate a conventional matching method to find the object block in preceding image 601 for macroblock 610. The method in FIGS. 6(a)-6(f) is to compare each macroblock of a digital image with each pixel block, i.e., a block of pixels of the same size and same shape as the macroblock in the preceding image, to determine the difference measure for each pixel block. The pixel block with the lowest difference measure is determined to be the origin block of the macroblock. As illustrated in FIG. 6(a), a group of pixels 610 with reference pixel RP(0,0), in preceding image 601 is compared to an 8×8 macroblock MB(x, y) to determine a difference measure for the group of pixels 610. Then as illustrated in FIG. 6(b), the group of pixels 620 with reference pixel RP(1,0), is compared to macroblock MB(x, y) to determine a difference measure for pixel block 620. Each pixel block having a reference pixel RP(j,0), where j is an integer from 0 to 19, inclusive, compared to macroblock MB(x, y) to determine a difference measure for the pixel block. Finally as illustrated, in FIG. 6(c) pixel block 630, with reference pixel RP(19,0) is compared with macroblock MB(x, y) to find a difference measure for pixel block 630. In the method of FIGS. 6(a)-6(f) the last pixel block in a row must have at least half the columns of pixels as in macroblock M(x, y). However, in some methods the last pixel block in a row may contain as few as one column. Thus, in these embodiments a pixel block having reference pixel RP(22,0) (not shown) may be used.

As illustrated in FIG. 6(d), after pixel block 630, pixel block 640, with reference pixel (0,1), is compared with macroblock MB(x, y) to determine a difference measure for pixel block 640. Each pixel block to the right of group of pixel 650 is then in turn compared to macroblock MB(x, y) to determine difference measures for each pixel block. Eventually, as illustrated in FIG. 6(e), the group of pixels 660 having reference pixel RP(19,1) is compared with macroblock MB(x, y) to determine difference measures for pixel block 660. This process continues until finally as illustrated in FIG. 6(f), pixel block 690 with reference pixel (19,11) is compared with macroblock MB(x, y) to determine a difference measure for pixel block 690. In some methods, the process continues until a pixel block having only one pixel within preceding image 601, e.g., a pixel block having reference pixel (22, 15) is compared with macroblock MB(x, y). Furthermore some embodiments may start with pixel blocks having reference pixels with negative coordinates. For example, rather than starting with pixel block 610 having reference pixels RP(0, 0), some methods would start with a pixel block having reference pixel RP(−7, −7). Conventional padding techniques can be used to fill the pixel block which require pixels that are outside of preceding image 601. A common padding technique is to use a copy of the closest pixel from preceding image 601 for each pixel outside of preceding image 601.

For large digital images the method illustrated in FIGS. 6(a)-6(f) would require a very large number of calculations to encode a digital image. For example, a 640×480 image comprises 1200 16×16 macroblocks of 256 pixels each. To encode a digital image from a preceding digital image would require comparing each of the 1200 16×16 macroblocks with each of the 298,304 pixel blocks (16×16 blocks) in the preceding image. Each comparison would require calculating 256 absolute differences. Thus, encoding of a digital image requires calculating approximately 91.6 billion absolute differences. For many applications this large number of calculations is unacceptable. For example, real time digital video data may need to be encoded for live broadcasts over a computer network, such as the internet. Since a digital video sequence ideally has 60 frames per second, the method of FIG. 6(a)-6(f) would require calculating approximately 5.4 trillion absolute differences per second. The computing power required to perform the calculations would be cost prohibitive for most applications. Hence there is a need for a method or structure to encode digital video streams, in which the computational overhead of motion estimation is reduced.

### SUMMARY

Accordingly, the present invention provides a method and system for encoding a digital video stream requiring less computer processing than conventional encoding methods. In one embodiment of the present invention, a video encoder encodes a digital video stream with intra-frames, predicted frames, and direct mode predicted frames. An intra-frame is a single image that is encoded with no reference to any past or future frames. A predicted frame is an image that is encoded relative to at least one past reference frame. Direct mode predicted frames are like conventional predicted frames except that motion vectors are not computed for direct mode predicted frames. In one embodiment of the present invention, direct mode predicted frames are transferred to a decoder without any motion vectors. During decoding, the decoder copies motion vectors from a co-located macro-block of a preceding predicted frame and applies the motion vector to the corresponding macro-block of the direct mode predicted frame. In another embodiment of the present invention, the encoder copies the motion vectors from a co-located macroblock of a preceding predicted frame for each macro-block of a direct mode predicted frame so that conventional decoders can be used with digital video streams incorporating direct mode predicted frames.

The present invention will be fully understood in view of the following description and drawings.

### BRIEF DESCRIPTION OF THE DRAWINGS

FIG. 1(a) is an illustration of a digital video stream of digital images.

FIG. 1(b) is a diagram of a digital image comprising picture elements (pixels).

FIG. 2 is a block diagram of a digital video system.

FIG. 3 is an illustration of object encoding of a digital video stream.

FIG. 4. is a diagram of a digital image divided into macroblocks.

FIGS. 5(a)-5(b) are an illustration of typical macroblocks.

FIGS. 6(a)-6(f) illustrate a conventional method of determining motion vectors to encode a digital video stream.

FIG. 7 is an illustration of a conventional encoded digital video stream.

FIG. 8 is an illustration of a encoded digital video stream in accordance with one embodiment of the present invention.

FIG. 9 illustrates the data structure of a conventional macro-block in an predicted frame of an encoded digital video stream.

FIG. 10 illustrates the data structure of a macro-block in a direct mode predicted frame of an encoded digital video stream in accordance with one embodiment of the present invention.

FIG. 11 illustrates the data structure of a macro-block in a direct mode predicted frame of an encoded digital video stream in accordance with one embodiment of the present invention.

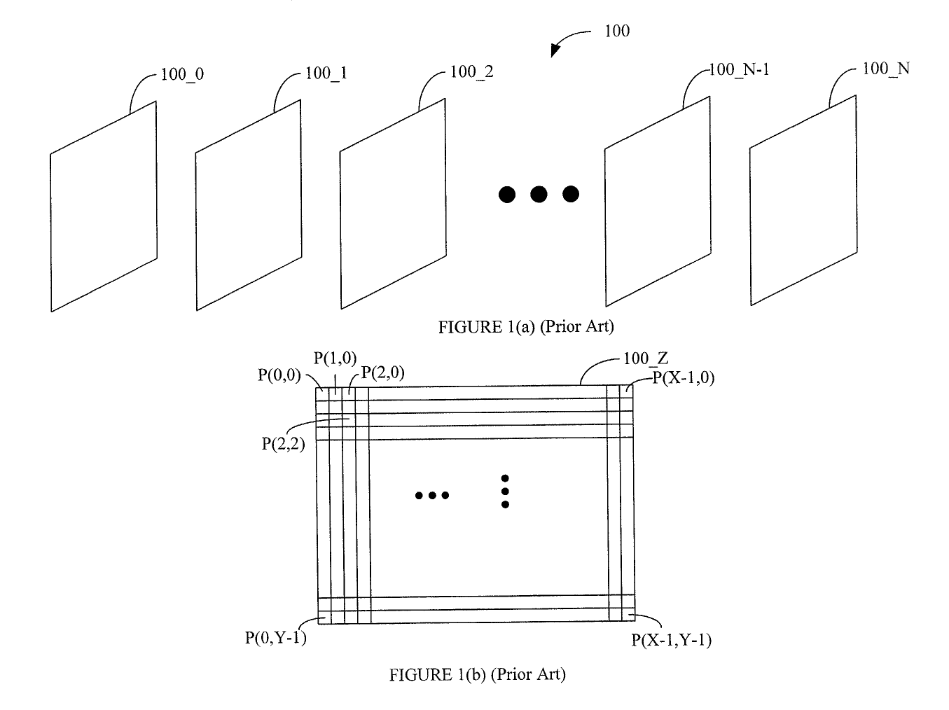

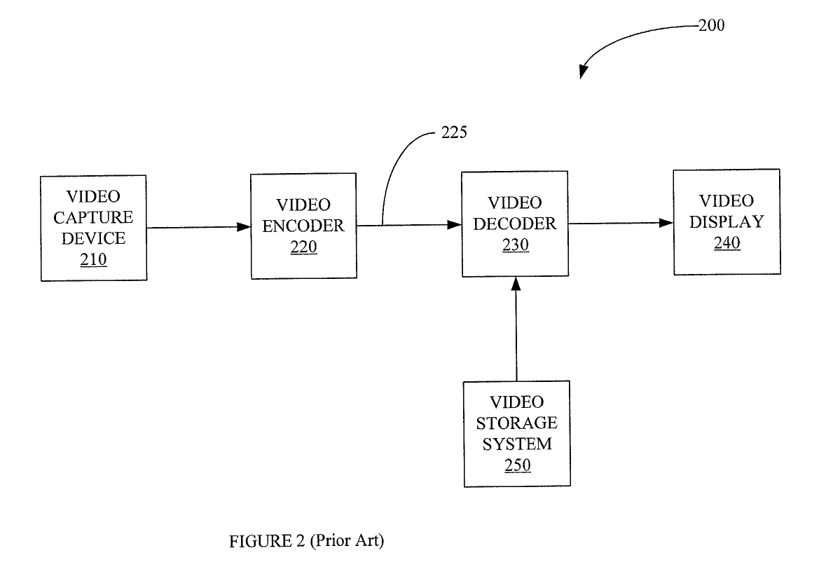

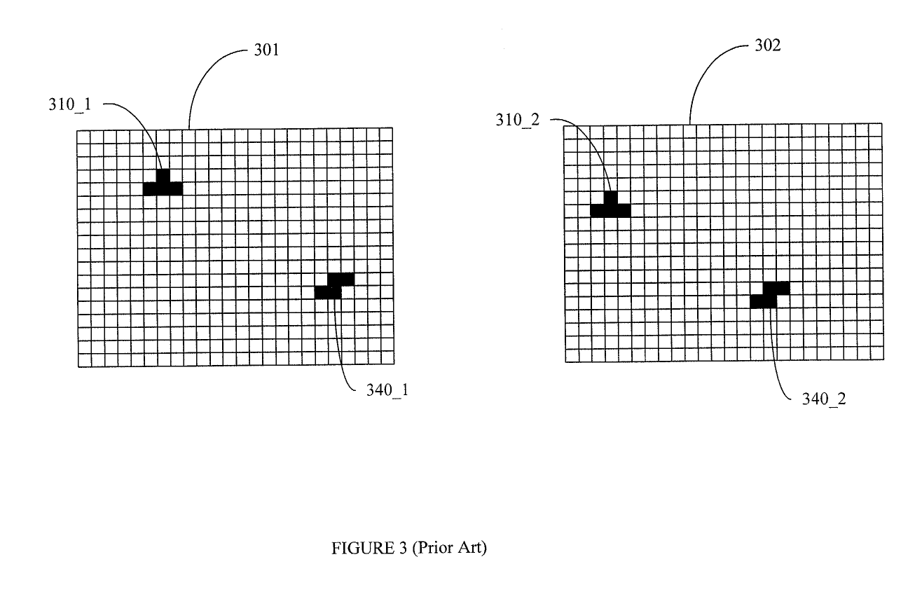

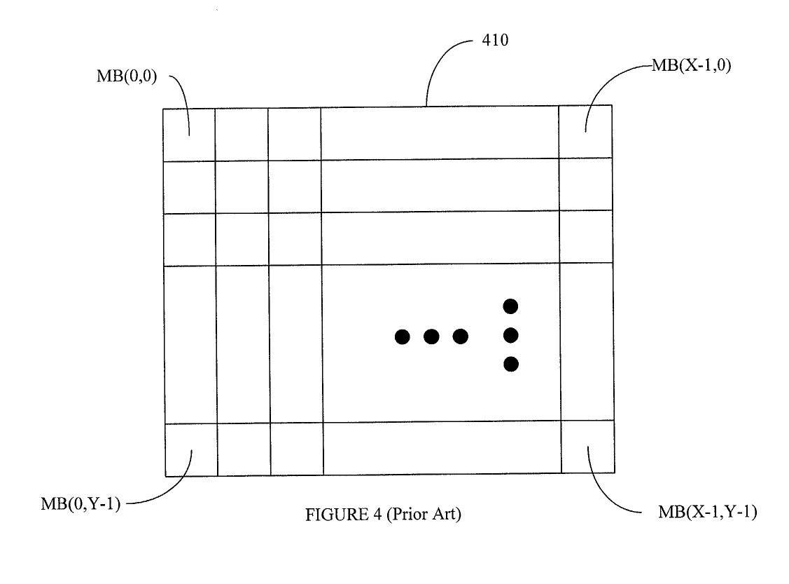

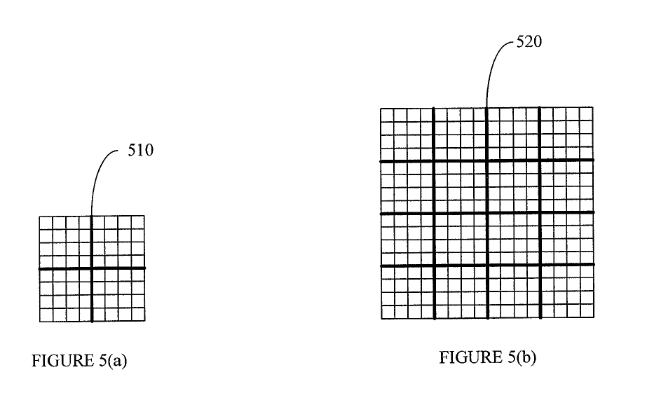

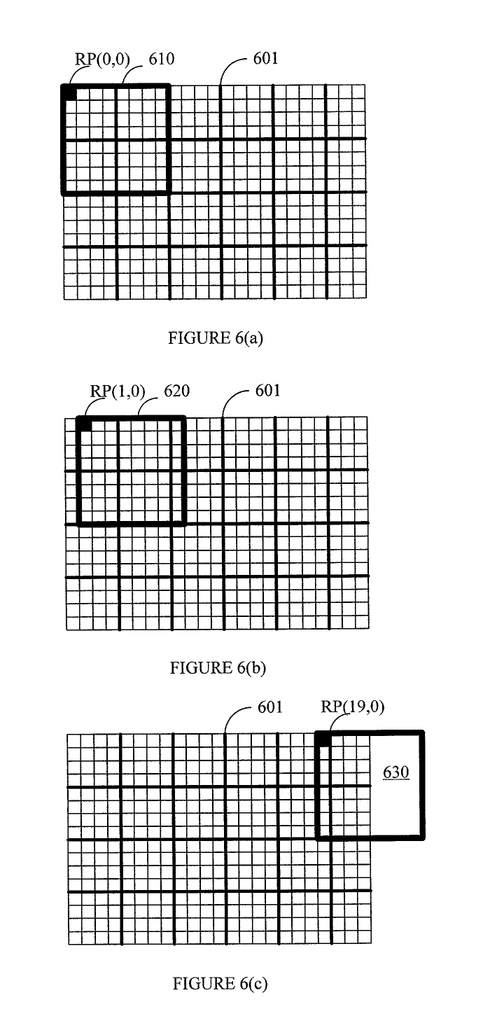

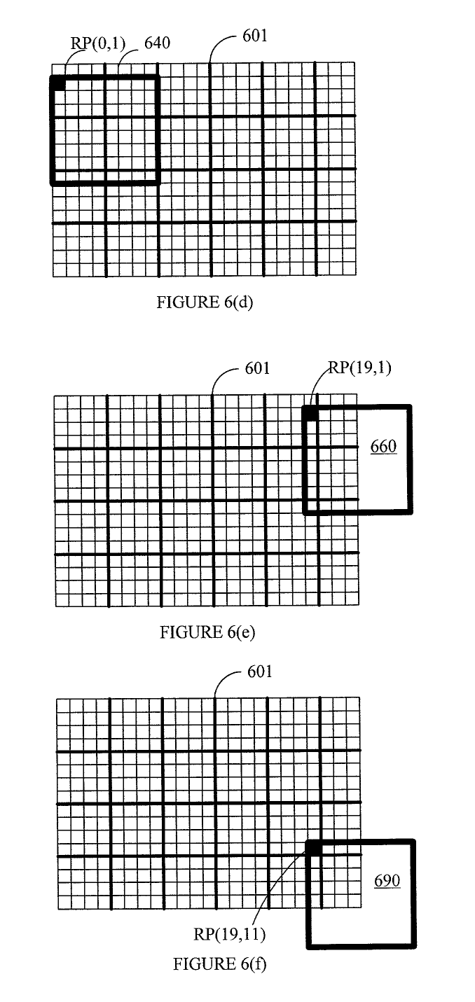

### DETAILED DESCRIPTION

As explained above, the computational overhead of computing motion vectors for full motion digital video is too great for many video encoding systems. Thus, in accordance with the present invention, the computational overhead required to determine the motion vectors of the macroblocks of an encoded digital video stream is reduced by reusing motion vectors and macro-block type information from a previous image frame.

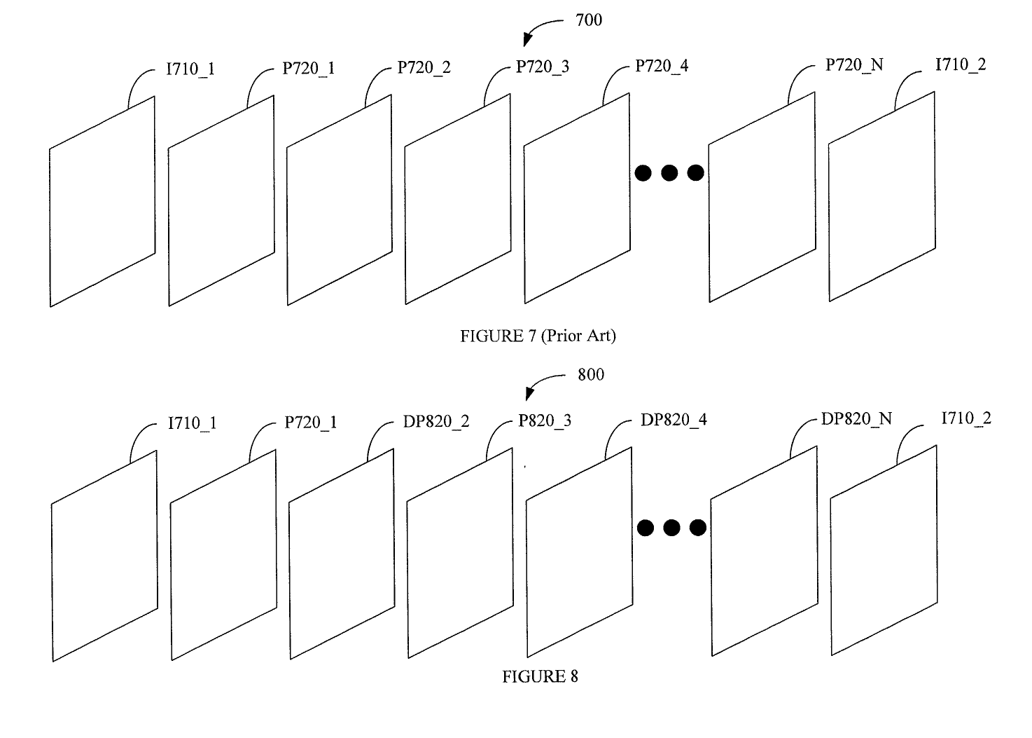

FIG. 7 illustrates a small portion of a conventional encoded digital video stream 700. The portion of encoded digital video stream 700 in FIG. 7 begins with an intra-frame (I-frame) 1710_1 and ends with an intra-frame 1710_2. In between the two intra frames are N predicted frames (P-frames) P720_1, P720_2, . . . P720_N. As is well known in the Art, an intra-frame is a single image that is encoded with no reference to any past or future frames. A predicted frame is an image that is encoded relative to at least one past reference frame for example with the use of macro-blocks and motion vectors as described above. Generally, predicted frames are encoded relative to the most recently preceding intra-frame or predicted frame. For example, predicted frame P720_1 is encoded relative to intra-frame 1710_0 and predicted frame P720_4 is encoded relative to predicted frame P720_3. Although not shown, many conventional encoding schemes also make use of bi-directional frames (B-Frames) which are encoded relative to a past reference frame and a future reference frame. Generally, bi-directional reference frames are encoded with reference to the closest past intra-frame or predicted frame and the closest next intra-frame or predicted frame. For clarity, bi-directional frames are not used in the examples presented herein. However, the principles of the present invention can easily be applied to encoding schemes using bi-directional frames.

As explained above, the computational overhead of calculating motion vectors is very large. Thus, in accordance to an embodiment of the present invention, a subset of the predicted frames are replaced with direct-mode predicted frames (DP-Frames). For example, FIG. 8 illustrates a portion of an encoded digital video stream 800 in accordance with one embodiment of the present invention. In encoded digital video stream 800, every other predicted frame is replaced with a direct mode predicted frame. Thus, predicted frames P720_2 and P720_4 of FIG. 7 are replaced with direct mode predicted frames DP820_2 and DP820_4, respectively, in FIG. 8. Similarly, each predicted frame P720_X is replaced with a direct mode predicted frame DP820_X, for even X. FIG. 8 is illustrated as if N is an even number. Thus, predicted frame P720_N is replaced with direct mode predicted frame DP720_N. Other algorithms can be used to select the subset of predicted frames that are replaced with direct mode predicted frames. For example, the motion vector information contained in the previous predicted frame can be used to determine whether the next frame should be a direct mode predicted frame. Two situations are well suited for direct mode predicted frames. Specifically, a direct mode predicted frame is well suited if the previous predicted frame does not have very much motion (i.e. the motions vectors of the previous frames are small). Direct mode predicted frames are also well suited when the motion in a scene is mainly translational global movement, such as panning imagery. For translational global movement the motion vectors of the previous predicted frame would all be very similar.

The primary difference between conventional predicted frames and direct mode predicted frames is that motion vectors calculations and related functions, such as macro-block type identification, are not performed for direct mode frames. Rather each macro-block in a direct mode frame is assumed to have motion vectors and macro-block types that are similar to the motion vectors and macro-block types of the closest preceding predicted frame.

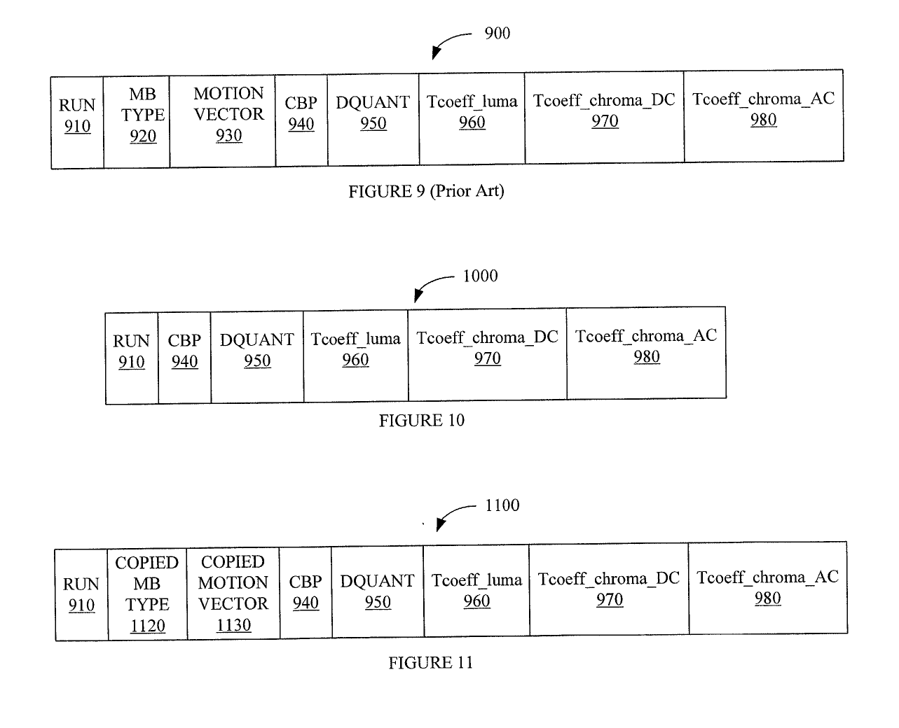

FIG. 9 illustrates the format of a macro-block 900 in a conventional predicted frame. For clarity, the FIG. 9 (as well as FIGS. 10-11) are based on the H.26L standard of the Joint Video Team of ISO/IEC MPEG & ITU-T VCEG. However, one skilled in the art can adapt the principles of the present invention to other video encoding schemes. Macro-block 900 includes a run section 910 followed by a macro-block type (MB TYPE) section 920, followed by a motion vector section 930, followed by a coded block pattern (CBP) section 940, followed by a difference of quantizer (DQUANT) section 950, followed by a luminance coefficient section (Tcoeff_luma) 960, followed by a DC chrominance section 970, and finally an AC chrominance section 980. Because FIGS. 9-11 are based on well known encoding schemes, specific sections of the macro-block format are not described in details herein. Run section 910 indicates how many macro-blocks have been skipped since the previous macro-block in the current frame. Macro-block type section 920 identifies the various block modes used within macro-block 900. Motion vector section 930 contains the motion vector for the macro-block. Coded block pattern section 940 contains a bit pattern that indicates which blocks of the macro-block are present. Difference of quantizer section 950 contains the difference in quantizer values between the current macro-block and the previous macro-block of the current frame. Luminance coefficient section 960 contains the luminance data for macro-block 900. DC chrominance section 970 and AC chrominance section 980 contains the color data for macro-block 900.

As explained above, calculation of the motion vectors is the most time and resource intensive task performed by a video encoder. By the motion vectors from the previous predicted to form motions vectors for the direct mode predicted frame, the computational overhead required for encoding a digital video stream is greatly reduced at the cost of a slight degradation in picture quality.

FIG. 10 illustrates the format of a macro-block 1000 in direct mode predicted frame in accordance with one embodiment of the present invention. Specifically, macro-block 1000 includes all the sections of macro-block 900 except that macro-block type section 920 and motion vector section 930 are omitted. In one embodiment of the present invention a decoder receiving a video stream containing a direct mode predicted frame, which contains macro-block 1000 would copy the macro-block type section and the motion vector section from the co-located macro-block of the preceding predicted frame. As used herein, a first macro-block in a first frame is co-located with a second macro-block in a second frame if the first macro-block and the second macro-block have the same location within the first and second frames, respectively. For example, if macro-block 1000 is in direct mode predicted frame DP820_4 of FIG. 8, then the video decoder would copy the macro-block type section and the motion vector section of the co-located macro-block in predicted frame P820_3. In other embodiments of the present invention, the motion vector for a current macro-block is formed based on the co-located macroblock in the preceding P frame and other macro-blocks near the co-located macro-block. For example, in a specific embodiment of the present invention the decoder finds the medium motion vector from among the motions vectors of the co-located macro-block in the preceding predicted frame and the macro-blocks directly above, below, to the left of, and to the right of the co-located macro-block. Other embodiments may use an average motion vector. Still other embodiments may use more or fewer macro-blocks from the preceding predicted frame to calculate a motion vector.

In some embodiments of the present invention, decoders receiving macro-blocks using the format of macro-block 1000, treat “skipped” macro-blocks differently than skipped macroblocks in conventional predicted frames. For skipped macroblocks in conventional predicted frames, the decoders copies co-located macro blocks from the previous predicted frame without applying motion vectors on the copied macro-block. However, for direct mode predicted frames, the decoder applies the motion vectors from copied macro-blocks or a calculated motion vector based on motion vectors from the preceding predicted frames.

In a specific embodiment of the present invention, the encoder forming direct mode predicted may occasionally include a zero motion vector in certain macro blocks of a direct mode predicted frame. Specifically, while encoding a current macroblock of the direct mode predicted frame, if the co-located macro-block of the previous predicted frame is an intra mode macro-block (i.e. a macro-block that is defined without reference to a other macro blocks) or a skipped macro-block, then the current macro-block is encoded as an intra-type macro-block with a zero motion vector. In another embodiment of the present invention, if the coded block pattern of the current macro block is zero then the encoder increases the run section of the current macro-block by one and does not encode the current macro-block information, which causes the current macro-block to become a “skipped” macro-block.

FIG. 11 illustrates the format of a macro-block 1100 for in a direct-mode predicted frame that can be used with conventional decoders while still benefiting from reduced computational overhead. Macro-block 1100 differs from macroblock 1000 by including a copied macro-block type section 1120 and a copied motion vector section 1130. Encoders using the format of macro-block 1100 copies the macro-block type section and the motion vector section from the co-located macro-block of the previous predicted frame and places the information into copied macro-block type section 1120 and copied motion vector section 1130. Rather than simply copying the motion vector from the co-located macro-block, some embodiments of the present invention calculate a motion vector based on motion vectors from the preceding predicted frame. For example, in a specific embodiment of the present invention a motion vector is calculated as the medium motion vector from the motion vectors among the co-located macro-block and the macro-blocks directly above, below to the left of and to the right of the co-located macro-block. From the decoder perspective, the format of macro-block 1100 is virtually identical to the format of macro-block 900 (from conventional predicted frame). Thus, from the decoder perspective, direct-mode predicted frame are treated the same as conventional predicted frames.

In the various embodiments of this invention, novel structures and methods have been described to reduce the computational overhead for encoding a digital video stream. By reusing motion vectors from previous frames in a direct mode predicted frame, the computational overhead of a direct mode predicted frame is greatly reduced as compared to conventional predicted frames. The various embodiments of the structures and methods of this invention that are described above are illustrative only of the principles of this invention and are not intended to limit the scope of the invention to the particular embodiments described. For example, in view of this disclosure, those skilled in the art can define other macro-block formats, direct-mode predicted frames, predicted frames, encoders, decoders, motion vectors, macro-block type sections, motion vector sections, encoders, decoders, and so forth, and use these alternative features to create a method or system according to the principles of this invention. Thus, the invention is limited only by the following claims.

What is claimed is:

1. An encoded digital video stream comprising:
a first intra-frame;
a second intra-frame following the first intra-frame;
a first plurality of predicted frames between the first intra-frame and the second intra-frame; and
a first plurality of direct-mode predicted frames between the first intra-frame and the second intra-frame.

2. The encoded digital video stream of claim 1, wherein the first plurality of predicted frames and first plurality of direct-mode predicted frames are interspersed between the first intra-frame and the second intra-frame.

3. The encoded digital video stream of claim 1, wherein the first plurality of direct mode predicted frames contain no motion vector data.

4. The encoded digital video stream of claim 1, wherein the first plurality of direct mode predicted frames contain no macroblock type data.

5. The encoded digital video stream of claim 1, wherein each direct-mode predicted frame contains a plurality of macroblocks.

6. The encoded digital video stream of claim 5, wherein a macro-block from the plurality of macro-blocks comprises:
a run section; and
coded block pattern section following the run section.

7. The encoded digital video stream of claim 6, wherein the macro-block further comprises:
a difference of quantizer section;
a luminance coefficient section;
a DC chrominance section; and
an AC chrominance section.

8. The encoded digital video stream of claim 1, wherein each direct mode predicted frame contains a copied motion vector section containing motion vector data copied from a preceding predicted frame.

9. The encoded digital video stream of claim 8, wherein each direct mode predicted frame also contains a copied macroblock type section containing macro-block type data copied from a preceding predicted frame.

10. The encoded digital video stream of claim 1, further comprising:
a third intra-frame following the second intra-frame;
a second plurality of predicted frames between the second intra-frame and the third intra-frame; and
A second plurality of direct-mode predicted frames between the second intra-frame and the third intra-frame.

11. The encoded digital video stream of claim 1, further comprising a plurality of bi-directional frames between the first intra-frame and the second intra-frame.

12. A method of encoding an incoming digital video stream having a plurality of input frames into an encoded digital video stream; the method comprising:
encoding a first subset of input frame as a plurality of intra-frames;
encoding a second subset of input frames as a plurality of predicted frames;
encoding a third subset of input frames as direct-mode predicted frames.

13. The method of claim 12, wherein the plurality of direct mode predicted frames contain no motion vector data.

14. The method of claim 12, wherein the plurality of direct mode predicted frames contain no macro-block type data.

15. The method of claim 12, wherein each direct-mode predicted frame contains a plurality of macro-blocks.

16. The method of claim 15, wherein a macro-block from the plurality of macro-blocks comprises:
a run section; and
coded block pattern section following the run section.

17. The method of claim 16, wherein the macro-block further comprises:
a difference of quantizer section;
a luminance coefficient section;
a DC chrominance section; and
an AC chrominance section.

18. The method of claim 12 wherein the encoding a third subset of input frames as direct-mode predicted frames further comprises forming a current macro-block.

19. The method of claim 18, wherein the forming a current macro-block further comprises:
detecting a mode of a co-located macro-block in a preceding predicted frame;
encoding the current macro-block as an intra-type macro-block with a zero motion vector when the co-located macro-block is an intra-mode macro-block.

20. The method of claim 18, wherein the forming a current macro-block further comprises:
detecting a mode of a co-located macro-block in a preceding predicted frame;
encoding the current macro-block as an intra-type macro-block with a zero motion vector when the co-located macro-block is a skipped macro-block.

21. The method of claim 18, wherein the forming a current macro-block further comprises copying motion vector data from a co-located macro-block of a preceding predicted frame.

22. The method of claim 21, wherein the forming a current macro-block further comprises copying macro-block type data from a co-located macro-block of a preceding predicted frame.

23. The method of claim 18, wherein the forming a current macro-block further comprises:
calculating a medium motion vector from a plurality of macro-blocks from a preceding predicted frame; and
storing the medium motion vector into the current macro-block.

24. The method of claim 18, wherein the plurality of macroblocks from the preceding predicted frame comprises:
a co-located macro-block of the preceding predicted frame;
a macro-block directly above the co-located macroblock;
a macro-block directly below the co-located macroblock;
a macro-block directly to the left of the co-located macro-block; and
a macro-block directly to the right of the co-located macro-block;

25. The method of claim 18, wherein the forming a current macro-block further comprises:
calculating an average motion vector from a plurality of macro-blocks from a preceding predicted frame; and
storing the average motion vector in the current macroblock.

26. A method of decoding an encoded video stream having intra-frames, predicted frames, and direct mode predicted frames, wherein each direct mode predicted frame includes a plurality of macro-blocks, the method comprising:
decoding an intra-frame;
decoding an predicted frame;
decoding a direct mode predicted frame using data from the predicted frame.

27. The method of claim 26, wherein the decoding a direct mode predicted frame using data from the predicted frame comprises copying motion vector data from the predicted frame.

28. The method of claim 27, wherein the decoding a direct mode predicted frame using data from the predicted frame comprises copying macro-block type data from the predicted frame.

29. The method of claim 27, wherein copying motion vector data from the predicted frame comprises copying motion vector data from a co-located macro-block of the predicted frame for a current macro-block of the direct mode predicted frame.

30. The method of claim 29, copying motion vector data from the predicted frame further comprises copying macro-block type data from a co-located macro-block of the predicted frame for a current macro-block of the direct mode predicted frame.

31. The method of claim 26, wherein the decoding a direct mode predicted frame using data from the predicted frame further comprises decoding a plurality of macro-blocks within each direct mode predicted frame.

32. The method of claim 31, wherein the decoding a plurality of macro-blocks within each direct mode predicted frame further comprises:
detecting a skipped macro-block in a direct mode predicted frame;
copying a co-located macro-block from a preceding predicted frame for the skipped macro-block; and
applying a motion vector from the co-located macroblock in the direct mode predicted frame containing the skipped macro-block.

33. The method of claim 31, wherein the decoding a plurality of macro-blocks within each direct mode predicted frame further comprises:
calculating a medium motion vector for a current-macroblock of the direct mode predicted frame from a plurality of macro-blocks from a preceding predicted frame;
applying the medium motion vector on the current macroblock.

34. The method of claim 33, wherein the plurality of macroblocks from the preceding predicted frame comprises:
a co-located macro-block of the preceding predicted frame;
a macro-block directly above the co-located macro-block;
a macro-block directly below the co-located macro-block;
a macro-block directly to the left of the co-located macro-block; and
a macro-block directly to the right of the co-located macro-block;

35. The method of claim 31, wherein the decoding a plurality of macro-blocks within each direct mode predicted frame further comprises:
calculating a average motion vector for a current-macro-block of the direct mode predicted frame from a plurality of macro-blocks from a preceding predicted frame;
applying the average motion vector on the current macroblock.

36. A video encoder for encoding an incoming digital video stream having a plurality of input frames into an encoded digital video stream; the video encoder comprising:
means for encoding a first subset of input frame as a plurality of intra-frames;
means for encoding a second subset of input frames as a plurality of predicted frames;
means for encoding a third subset of input frames as direct-mode predicted frames.

37. The video encoder of claim 36, wherein the plurality of direct mode predicted frames contain no motion vector data.

38. The video encoder of claim 36, wherein the plurality of direct mode predicted frames contain no macro-block type data.

39. The video encoder of claim 36, wherein each direct-mode predicted frame contains a plurality of macro-blocks.

40. The video encoder of claim 36 wherein the means for encoding a third subset of input frames as direct-mode predicted frames further comprises means for forming a current macro-block.

41. The video encoder of claim 40, wherein the means for forming a current macro-block further comprises:
means for detecting a mode of a co-located macro-block in a preceding predicted frame;
means for encoding the current macro-block as an intra-type macro-block with a zero motion vector when the co-located macro-block is an intra-mode macro-block.

42. The video encoder of claim 40, wherein the means for forming a current macro-block further comprises:
means for detecting a mode of a co-located macro-block in a preceding predicted frame;
means for encoding the current macro-block as an intra-type macro-block with a zero motion vector when the co-located macro-block is a skipped macro-block.

43. The video encoder of claim 40, wherein the means for forming a current macro-block further comprises means for copying motion vector data from a co-located macro-block of a preceding predicted frame.

44. The video encoder of claim 43, wherein the means for forming a current macro-block further comprises means for copying macro-block type data from a co-located macro-block of a preceding predicted frame.

45. The video encoder of claim 40, wherein the means for forming a current macro-block further comprises:
means for calculating a medium motion vector from a plurality of macro-blocks from a preceding predicted frame; and
means storing the medium motion vector into the current macro-block.

46. A Video decoder for decoding an encoded video stream having intra-frames, predicted frames, and direct mode predicted frames, wherein each direct mode predicted frame includes a plurality of macro-blocks, the video decoder comprising:
means for decoding an intra-frame;
means for decoding an predicted frame;
means for decoding a direct mode predicted frame using data from the predicted frame.

47. The video decoder of claim 46, wherein the means for decoding a direct mode predicted frame using data from the predicted frame comprises means for copying motion vector data from the predicted frame.

48. The video decoder of claim 47, wherein the means for decoding a direct mode predicted frame using data from the predicted frame comprises means for copying macro-block type data from the predicted frame.

49. The video decoder of claim 47, wherein means for copying motion vector data from the predicted frame comprises means for copying motion vector data from a co-located macro-block of the predicted frame for a current macro-block of the direct mode predicted frame.

50. The video decoder of claim 49, wherein the means for copying motion vector data from the predicted frame further comprises means for copying macro-block type data from a co-located macro-block of the predicted frame for a current macro-block of the direct mode predicted frame.

51. The video decoder of claim 46, wherein the means for decoding a direct mode predicted frame using data from the predicted frame further comprises means for decoding a plurality of macro-blocks within each direct mode predicted frame.

52. The video decoder of claim 51, wherein the means for decoding a plurality of macro-blocks within each direct mode predicted frame further comprises:
means for detecting a skipped macro-block in a direct mode predicted frame;
means for copying a co-located macro-block from a preceding predicted frame for the skipped macro-block; and
means for applying a motion vector from the co-located macro-block in the direct mode predicted frame containing the skipped macro-block.

53. The video decoder of claim 51, wherein the means for decoding a plurality of macro-blocks within each direct mode predicted frame further comprises:
means for calculating a medium motion vector for a current-macro-block of the direct mode predicted frame from a plurality of macro-blocks from a preceding predicted frame;
means for applying the medium motion vector on the current macro-block.
